(19) United States
(12) Patent Application Publication
(10) Pub. No.: US 2007/0282726 A1
(43) Pub. Date: Dec. 6, 2007

(54) Method and system for identifying and managing currency exposure

(75) Inventors: Wolfgang J. Koester, Paradise Valley, AZ (US); Corey D. Edens, Scottsdale, AZ (US)

Correspondence Address: DRINKER BIDDLE & REATH (DC), 1500 K STREET, N.W., SUITE 1100, WASHINGTON, DC, 20005-1209, US

(73) Assignee: Rim Tec, Inc., Scottsdale, AZ (US)

(21) Appl. No.: 11/806,151

(22) Filed: May 30, 2007

Related U.S. Application Data
(60) Provisional application No. 60/811,297, filed on Jun. 5, 2006.

(51) Int. Cl. G06Q 40/00

(52) U.S. Cl. 705/35

(57) ABSTRACT

A method and system for identifying and managing currency exposure is provided. In certain implementations, a company's accounting data, including the data of its subordinate entities, is uploaded to one or more servers. Each entity's foreign currency exposures are calculated. Foreign currency exposures of different entities that offset one another may be netted. Similar currency exposures are summed across all entities. Each resulting currency exposure is converted to the company's reporting currency. The converted currency exposures of the entities are summed together to report the gross currency exposure for the company. To calculate the overall net currency exposure for the company, the value of the currency-based derivatives represented in the company's reporting currency is subtracted from the gross currency exposures of the company. The overall net currency exposure for the company is displayed on a web interface, along with possible courses of action that may be taken to bring the company into compliance with currency exposure policies. The user may request that displayed actions be taken. If such a request is made, an electronic message is generated and sent to one or more persons who are authorized to approve the requested actions. When the company approves a suggested currency action, the system executes the currency transaction in such a way as to ensure price execution quality. The system then sends a transaction confirmation and settlement report to the company and reconciles the currency transactions and positions with the executing counterparty.

### CROSS-REFERENCE TO RELATED APPLICATIONS

This patent application claims the benefit of U.S. Provisional Patent Application No. 60/811,297, filed Jun. 5, 2006, the entire contents of which being incorporated herein by reference.

### TECHNICAL FIELD

The invention relates generally to currency exposure management and, more, particularly, to computer-implemented methods and systems for determining currency exposure for companies that have multiple entities and then recommending various currency actions to effectively reduce the exposure to an acceptable level.

### BACKGROUND

Companies that do business internationally and have foreign entities must identify the functional currency for each entity. A “functional currency” is the currency in which the entity normally transacts business. It is usually the currency of the economic environment in which cash is generated and expended by the entity. However if the entity is deemed to be an integrated foreign entity (i.e. operates as an extension of the parent compared to a self-sustaining entity) or the functional currency is a hyperinflation currency (i.e., the 3-year inflation rate is approximately 100% or greater) then the entity will likely use the currency of the parent company as its functional currency. The company as a whole (the parent company plus its entities) will also have a “reporting currency.” The reporting currency is the currency used by the company to report financial statements and documents. The parent company's functional currency is typically used as the reporting currency.

When an entity transacts business in a currency other than its functional currency (hereafter referred to as a “non-functional currency”), it may end up with cash, accounts receivable, accounts payable, intercompany receivables, intercompany payables and other monetary balances (generally “accounts”) that are denominated in a non-functional currency. If this occurs, then the entity is said to have a “currency exposure,” which is expressed as a pair of currencies (e.g., “dollar to yen exposure”). This is because the value of the non-functional currency may change over time compared to the functional currency. Thus, the value of the transaction will also change, causing a gain or loss. The risk of such a gain or loss in a transaction is called a “currency risk.” A currency risk can exist in transactions between the parent and its entities, the parent and its vendors, or the parent and its customers. It may also exist in transactions between an entity and its vendors or an entity and its customers. The currency exposures of all of the entities results in a currency risk for the company as a whole. This currency risk is important because it affects a company's profits. The gain or loss from the change in value of the cash and cash equivalent assets and liabilities can have a material effect on a company's earnings if they are not managed properly. The impact on earnings also complicates decision-making for investors, since the results of the company may no longer reflect the skills of the management team, but instead reflect unpredictable fluctuations in the currency markets. For example, the currency exposure could have the effect of increasing profits when there are favorable currency movements, giving the illusion that management is doing a better job at managing the company than it actually is.

One way to address currency exposure is to convert all non-functional currency accounts into functional currencies. This is not always possible, however. For example, an account receivable can not be converted to the functional currency because there is no cash that can be sold to accomplish the conversion. Another way to address currency exposure is for the company to buy or sell currency-based derivatives to offset or “hedge” the exposure. The set of derivatives that the company has at a particular point in time is called a “hedge.” Each derivative or hedge is denominated as a pair of currencies (e.g., dollar vs. yen). The term “derivatives” includes forward contracts, options, or other financial instruments that have their price related to, or derived from, an underlying product.

Regardless of how a company addresses currency exposure, it is important for the company to be able to determine the amount of their currency exposure in a timely fashion, and to quickly take the appropriate actions. Thus, it can be seen that there is a need for a method and system for identifying and managing currency exposure.

### SUMMARY

In accordance with foregoing, a method and system for identifying and managing currency exposure is provided. There are several possible embodiments of this invention. In certain embodiments, a company's accounting data and derivative data, including the data of its subordinate entities, is uploaded to one or more servers. Each entity's foreign currency exposures (e.g., the exposure that the entity has to any non-functional currencies) are calculated. Foreign currency exposures of different entities that offset one another may be netted. Similar currency exposures are summed across all entities. Each resulting currency exposure is converted to the company's reporting currency. The converted currency exposures of the entities are summed together to report the gross currency exposure for the company. To calculate the overall net currency exposure for the company, the value of the currency-based derivatives represented in the company's reporting currency is subtracted from the gross currency exposures of the company. As with a currency exposure, each derivative is denominated in two currencies. The two currencies of the derivative positions are specifically matched to the currency exposures (the two currencies of a currency exposure must match the two currencies of a derivative position). For each currency exposure, the net currency exposure is calculated by subtracting the derivative positions from the matching gross currency exposure. Each resulting net currency exposure is converted to the company's reporting currency and summed to obtain the overall net exposure for the company. The overall gross and overall net currency exposures for the company are displayed on a web interface, along with possible courses of action that may be taken to bring the company's currency exposure into compliance with the currency exposure policies. The web interface gives the user the option to request that suggested actions be taken. If such a request is made, an electronic message is generated and sent to one or more persons who are authorized to approve the requested actions. When the company approves a suggested currency action, the system executes the currency transaction in such a way as to ensure price execution quality. The system then sends a transaction confirmation and settlement report to the company and reconciles the currency transactions and positions with the executing counterparty.

### BRIEF DESCRIPTION OF THE DRAWINGS

FIG. 1 shows the operation of a system configured according to an embodiment of the invention.

FIG. 2 shows a functional view of a system configured according to an embodiment of the invention.

FIG. 3 is a flowchart showing steps performed in an embodiment of the invention.

FIG. 4 shows an example of a hardware infrastructure on which the invention may be carried out.

### DETAILED DESCRIPTION

Described herein is a system and method for identifying and managing currency exposure. The system and method enable a company, also referred herein as the “parent company,” that has subordinate entities (also referred to as “entities,” which are extensions of the company itself or “child” companies that operate independently, but report to the parent company) to calculate the overall currency exposure for the company in terms of the company's reporting currency. In one embodiment, the system collects identification and financial information pertaining to each individual entity, and uses this information to calculate currency exposures for each individual entity in terms of the entity's functional currency. Foreign currency exposure of different entities that offset one another may be netted. The system then converts each currency exposure for each entity into the reporting currency of the company. Then, all currency exposures are summed up, resulting in an “overall gross currency exposure” for the parent company. Furthermore, each individual currency exposure for the company is adjusted to account for currency derivatives owned by the company. The adjusted currency exposures are then converted to the reporting currency and summed, resulting in a value that is referred to as the “overall net currency exposure” for the company. After the overall net currency exposure is calculated, the system uses the company's foreign currency risk tolerance and decision guidelines to create suggested actions. These suggested actions are intended to bring the company's overall net currency exposure within the requirements of the company's foreign currency risk policy. The company may then deselect, adjust or add currency actions that are to be suggested. The company may then see the impact of the changes on the overall net currency exposure. When the company approves a suggested currency action, the system executes the currency transaction in such a way as to ensure price execution quality. The system then sends a transaction confirmation and settlement report to the company and reconciles the currency transactions and positions with the executing counterparty.

Various embodiments of the invention provide a method for supporting the calculation of both overall gross currency exposure and overall net currency exposure. According to these embodiments, “netting groups” may be defined. A netting group is an arbitrary group of entities defined for specific business purposes whose currency exposures may counter-balance one another. For example, assume that entity A and entity B are in the same netting group. If entity A has a functional currency that is the same as a non-functional currency of entity B, and entity B has a functional currency that is the same as a non-functional currency of entity A, then the currency exposures of these two entities may counterbalance one another. For example, a British Pounds Sterling vs. Euro currency exposure in one entity (on either the asset or liability side) may partially counter-balance a Euro vs. British Pounds Sterling exposure in another entity, if the two entities are in the same netting group. After all of the counter-balancing exposures within each netting group have been eliminated (since the counter-balancing exposures do not contribute to the overall gross currency exposure for the company), the remaining currency exposures of the company are expressed in terms of the reporting currency and summed. The resulting sum is the overall gross currency exposure for the company. The overall net currency exposure for the company is then calculated by adjusting each currency exposure by the total value of similar derivatives, converting the result into the reporting currency and then summing each of the netted currency exposures.

One embodiment of the invention includes the steps of (a) gathering data regarding the company's monetary assets and liabilities from the company's records; (b) obtaining currency exchange rates for all of the company's non-functional currencies (including those of its subordinate entities); (c) calculating the company's overall gross currency exposure by assessing individual currency exposures, using currency rates and the gathered asset and liability data; (d) gathering information regarding the company's derivatives; and, (f) calculating the overall net currency exposure of the company by adjusting each currency exposure by the value of the derivatives for that currency exposure and then summing all of the adjusted exposures. The overall currency exposure, the value of the derivatives and the overall net currency exposure are all presented on a web page in terms of the company's reporting currency.

According to another embodiment of the invention, a method is provided for minimizing a company's currency exposure. The currency exposure minimization method may include one or more of the following steps: (a) determining intercompany transactions that can be paid (intercompany transactions are those transactions between a parent company and its entities or between entities within the same company); (b) determining if any cash conversions can be performed to cover excess cash balances or accounts payable balances; (c) identifying any remaining currency exposure and the amounts that require actions; (d) proposing actions that can be taken to bring the company in compliance with the company's foreign currency risk policy; (e) notifying properly authorized individuals that there are proposed currency actions pending approval based on the decision rules and decision process; (f) receiving approval for a subset of the proposed actions from the properly authorized individuals; (g) executing the approved actions.

According to another embodiment of the invention, a method is provided for executing, confirming and reconciling currency transactions. The method of this embodiment includes the following steps: (a) displaying live foreign currency interbank market data; (b) obtaining a quote from a counterparty; (c) verifying that the quote is within trading rule parameters; (d) if the counterparty quote is within parameters, executing the currency transaction with the counterparty; (e) continuing to reevaluate quotes until they are within trading rule parameters; (f) executing the appropriate currency transactions; (g) sending details of the executed currency transactions to the company; (h) reconciling executed currency transaction details with the counterparty or counterparties; and (i) sending details of executed currency transaction settlements to the company and to the counterparty.

Prior to any further description, some of the terms used herein will now be clarified. Hereinafter, the term “network” refers to a connection between any two or more computational devices, which permits the transmission of data.

Hereinafter, the term “computational device” includes but is not limited to, personal computers (PC) having an operating system such as DOS, Windows, OS/2 or Linux; Macintosh computers; computers having JAVA-OS as the operating system; graphical workstations such as the computers of Sun Microsystems and Silicon Graphics, and other computers having some version of the UNIX operation system such as AIX or Solaris or Sun OS, or any other known and available operating system, or any device including but not limited to: servers, desktops, laptops, hand-held computers, PDA (personal data assistant) devices, cellular telephones, any type of WAP (wireless application protocol) enabled device, wearable computers of any sort, which can be connected to a network.

Hereinafter, the term “Windows” includes but not limited to Windows 95, Windows 3.X where X is an integer such as “1,” Windows NT, Windows 98, Windows CE, Windows 2000, and any upgraded versions of the Windows-brand operating system by Microsoft Corporation.

For the system described herein, a software application could be written in substantially any suitable programming language, which could easily be selected by one of ordinary skill in the art. The programming language chosen should be compatible with the computational device according to which software application is executed. Examples of suitable programming languages include, but are not limited to C, C++, VisualBasic, and Java. Hereinafter, the term “Host Server” refers to the application that runs the system and method.

In addition, the system could be implemented as software, firmware or hardware, or as a combination thereof. For any of these implementations, the functional steps performed by the system and method could be described as a plurality of instructions performed by a processor.

Hereinafter, the term “Web browser” refers to any software program which can display text, graphics, or both from Web pages on the World Wide Web sites. Hereinafter, the term “web server” refers to a server capable of transmitting a Web page to the Web browser upon request.

Hereinafter, the term “Web Page” refers to any document written in a mark-up language including, but not limited to, HTML (hypertext mark-up language) or VRML (virtual reality modeling language), dynamic HTML, XML (extensible mark-up language) or XSL (XML styling language), or related computer languages thereof as well as to any collection of such documents reachable through one specific Internet address or at one specific World Wide Web site, or any document obtainable through a particular URL (Uniform Resource Locator). The term “web interface” is a web page rendered so as to be viewable. Hereinafter, the term “Web site” refers to at least one Web-page, and preferably a plurality of Web pages, virtually connected to form a coherent group.

Hereinafter, the phrase “display a Web page” includes actions necessary to render at least a portion of the information on the Web page available to the computer user. As such, the phrase includes, but is not limited to, the static visual display of the static graphical information, the animated visual display of animation and the visual display of video stream data.

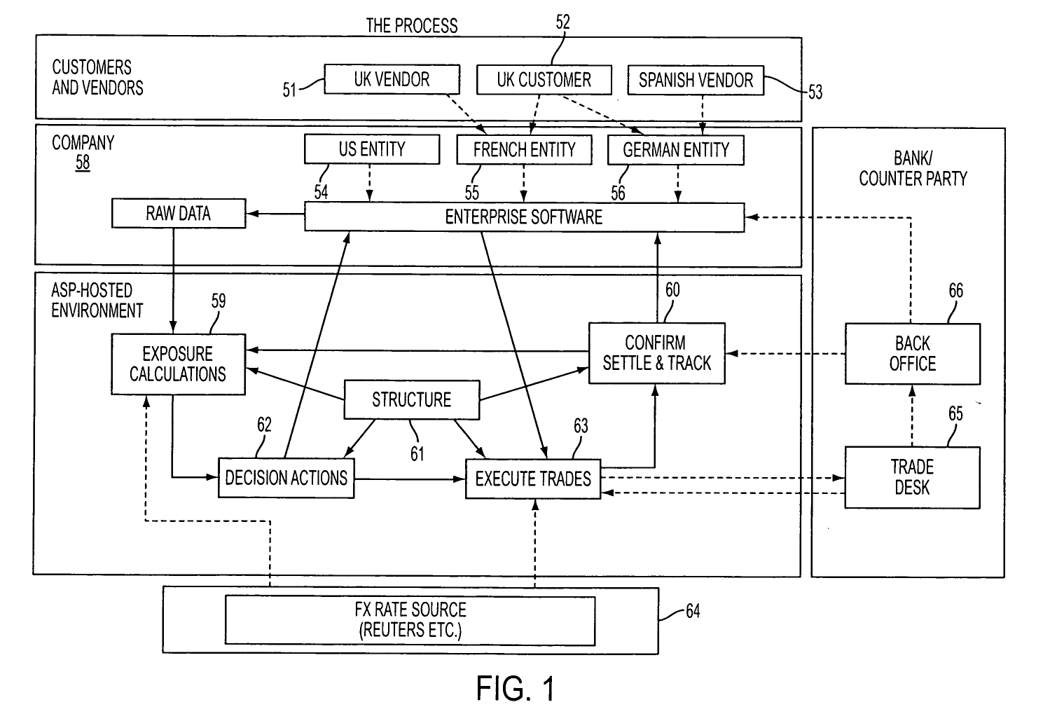

Referring to FIG. 1, a system (10) for implementing an embodiment of the invention will now be described. The system (10) includes several functional components that operate in an Application Service Provider (ASP) hosted environment. These components include an Exposure Calculation engine (59), a Decision engine (62), a Currency Transaction engine (63), and a Settlement engine (60). These components interact with one another via a computer Hardware Infrastructure (61) as shown by the relevant arrows. The Hardware Infrastructure (61) includes one or more computers, digital storage devices (which may, themselves, be computers) and the appropriate networking infrastructure (e.g., routers, hubs, switches, gateways, Ethernet cables, wireless interfaces, fiber optic media). It is to be understood that the functional components (59, 60, 62, and 63) may be part of a single piece of software or may be distributed among multiple pieces of software, and that the functions of each component may be performed by multiple computers and/or pieces of software. It is also to be understood that, in alternative embodiments, the functions of any or all of the components may be performed, at least in part, by a human. The system (10) is used by a Company (58), which can access the system (10) by, for example, the Internet. The system (10) interacts with a Foreign Exchange (FX) Source (64) (e.g., Reuters), and with a Bank/Counter Party (12). The Bank/Counter Party (12) includes a Trade Desk (65) and a Back Office (66), which interact with the system (10) and the Company (58) as shown.

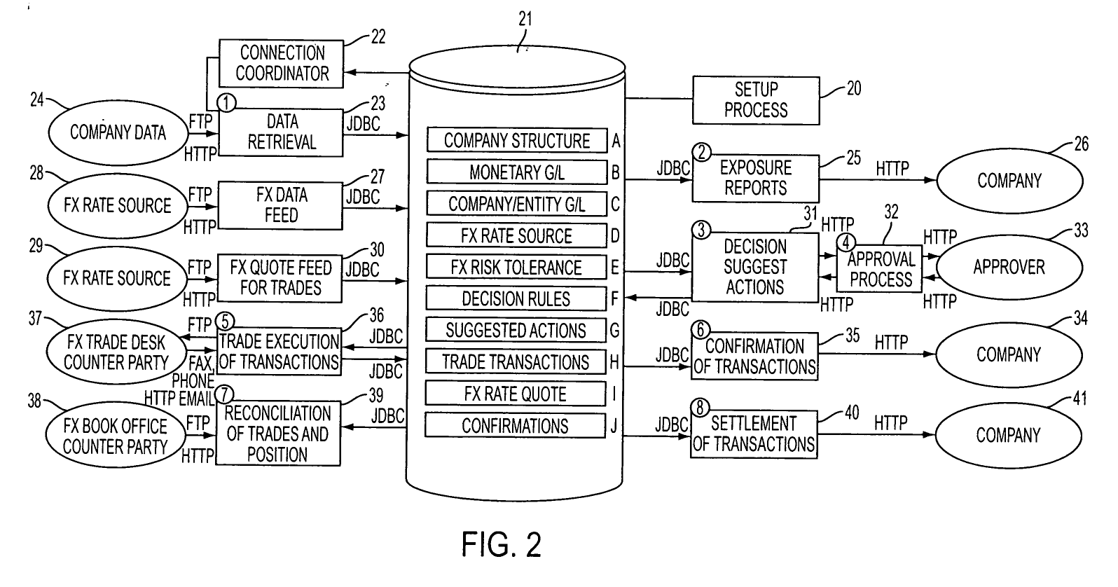

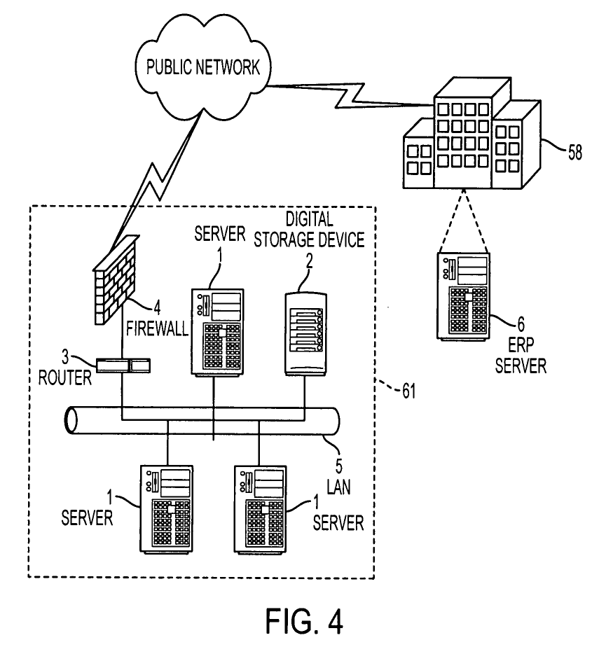

There are many possible configurations for the computer Hardware Infrastructure (61). Referring to FIG. 4, one possible configuration will now be described. In this configuration, the Hardware Infrastructure (61) includes a plurality of servers (1) that execute one of more of the software components described above, a digital storage device (2) that stores a database (an example of which is the database 21 of FIG. 2), a router (3) that routes data traffic among the components of the Hardware Infrastructure (61), a firewall (4) that permits only authorized access to the Hardware Infrastructure (61) and its software components, and a Local Area Network (LAN) 5 over which the various components of the Hardware Infrastructure communicate. The Hardware Infrastructure (61) in this embodiment is communicatively linked to an Enterprise Resource Planning (ERP) server or servers (6), which can also be referred to as the ERP system, at the Company (58) via a public network (such as the Internet), although the communications may be encrypted (e.g., via a virtual private network). These ERP servers may centralized in one location or may be geographically distributed around the world. The Exposure Calculation engine (59) (from FIG. 1) receives the Raw Data (26) from the ERP server (6) in this embodiment. The servers (1) can retrieve data from the database of the digital storage device (2).

In one embodiment of the invention, the servers (1) and the digital storage device (2) of the computer Hardware Infrastructure (61) host: (1) a database that contains data representing the company's set up information (users, user rights, passwords, entities, the functional currency for each entity, netting groups), the company's monetary assets and liabilities, the company's currency-based derivatives and the currency exchange rate data; (2) software applications, including the Exposure Calculation engine (59); (3) security firewall(s); and (4) load balancing technology. These servers carry out a process, referred herein as “Process 1.” According to Process 1, the servers retrieve assets and liabilities data for the entire company from the database, including those of the subordinate entities of the company. The servers also retrieve, from the database, data regarding the currency-based derivatives owned by the company. The servers obtain the exchange rates between the non-functional, functional and reporting currencies. The servers execute the Exposure Calculation engine (59), which receives, as input, the assets and liabilities data. The Exposure Calculation engine eliminates counter-balancing exposures (e.g., within each netting group), and, for each entity, converts the remaining individual currency exposures into the company's reporting currency. The Exposure Calculation engine (59) sums the remaining individual currency exposures to obtain an overall gross currency exposure for the company. The overall gross currency exposure (which represents the company's overall monetary exposure) is then displayed on a web page in terms of the reporting currency. The Exposure Calculation engine (59) converts the currency-based derivatives data into the reporting currency, sums the currency-based derivatives data, and displays the sum on the web page. This sum represents the current total value of the derivatives owned by the company. The Exposure Calculation engine (59) calculates the net currency exposure of the company by taking the difference between the currency exposure and the value of the matching derivatives for each currency exposure and summing. The overall currency exposure, the value of the derivatives and the net currency exposure are all presented on a web page in the terms of the company's reporting currency.

In another embodiment of the invention, the servers (1) and the digital storage device (2) of the computer Hardware Infrastructure (61) host: (1) a database containing data representing the company's foreign currency risk decision parameters (decision thresholds, minimum cash balances, minimum payment amounts), the overall gross currency exposure and overall net currency exposure for the company determined from Process 1, and email addresses of the parties within the company who have authority to approve currency actions; and (2) software, including the Decision engine (62). The servers carry out a process, referred to herein as “Process 2.” According to Process 2, the servers execute the Decision engine (62), which receives the overall gross and net exposures from Process 1 and, according to a decision algorithm embodied in the Decision engine (62), determines what currency actions are to be recommended. The Decision engine (62) displays a set of possible currency actions to a user on a web page. In doing so, the Decision engine (62) highlights the subset of the possible actions that fall within the company's risk policies and decision parameters (also referred to as the “recommended currency actions”). The Decision engine (62) also displays, on the same web page, the company's overall gross currency exposure, the value of its derivatives, and its net currency exposure, both before and after the effects of the recommended currency actions. In addition, a table also displays the summary total of currency conversion actions, intercompany payment actions and hedge adjustments. The web page permits the user to review the details behind the recommended currency actions (i.e., permits the user to see exactly what transactions caused the exposure that resulted in each recommended currency action). The web page also enables the user to deselect or adjust each recommended action, to select another action from the list of all currency actions (i.e., select an action that falls outside of the company's risk policies and decision parameters), or to create a new action not provided by the decision algorithm. Possible actions that may be shown and selected include buying or selling derivatives, converting a cash account of an entity from a non-functional currency to the entity's functional currency, paying off one or more intercompany accounts receivable (between two entities, or between the parent company and an entity) or purchasing foreign currency to make a future payment. The web page displays the effect of all user edits and changes to the currency actions on the company's overall exposure, value of derivatives and net currency exposure. Upon receiving the user's final decisions regarding which actions are to be taken, the servers create and send an email message to addressees on the email notification list and record the final approval for the set of actions in the database for audit purposes.

In yet another embodiment of the invention, the servers (1) and the digital storage device (2) of the computer Hardware Infrastructure (61) host: (1) a database having stored thereon data representing the approved currency actions from Process 2, approved counterparty information for the company, trading rule parameters and company currency settlement data; and (2) software that includes the Currency Transaction engine (63) and the Settlement engine (60). The servers carry out a process, herein referred to as “Process 3,” in which they execute the Currency Transaction engine (63), which converts the approved currency actions (from Process 2) into currency execution transactions. The Currency Transaction engine (63) displays, on a web page, live foreign currency interbank market data and relevant counterparty and trading rule parameters associated with the company. The Currency Transaction engine (63) obtains an electronic quotation from the counterparty or directly from the counterparty trading desk. If the counterparty quotation is within the trading rule parameters associated with the company, the Currency Transaction engine (63) executes the transaction. If the counterparty quotation is not within the parameters, the Currency Transaction engine (63) continues to evaluate the counterparty quotation until it is within the trading parameters or displays the trade execution exception for manual intervention. The Currency Transaction engine (63) provides an interface to enter the details of the currency transaction into the software if it has been executed manually. The servers also execute the Settlement engine (60). The Settlement engine (60) summarizes the details of the transactions in an electronic communication to both the company and counterparty to confirm the currency transaction, and provides currency transaction settlement instructions to the company and counterparty based on data stored in the database to facilitate movement of the currencies between the parties.

Referring to FIG. 2, another view of the system (10) (from FIG. 1) will now be described. In this view, both components and the steps carried out by the components are depicted. The components of the system (10) are labeled with numbers, and the steps carried out with those components are labeled with Step designations. In an embodiment of the invention, a Setup Process (20) initially configures the system (10). A customer or “client” interacts with the system (10) to make the appropriate inputs. The client may also be the “user” referred to in the descriptions of Process 1, Process 2, and Process 3 above. The client may be someone at the company itself, a software component at the company, or a third party working on behalf of the company. The client accesses the Setup Process (20), and enters information regarding company, its subordinate entities, and account information via a web site that is accessed over the World Wide Web (e.g., over the Internet). The system (10) includes a database (21), which contains tables (21A-21J). The database (21) may be maintained on a single storage medium or may be distributed. The database (21) corresponds to the “database” referred to in the descriptions of Process 1, Process 2, and Process 3 above. The structure of the company, the relationships of the entities to the company, the monetary accounts that will be exported from the company's accounting system, and the account types are stored in a Company and Account Structure table (21A). This table will typically be, but is not limited to, a tree structure. The client also enters the functional currency for each entity of the company and the reporting currency that the client wishes the resultant information to be displayed in. For the company and for each of its entities, the client configures an approval process. This approval process may be carried out via web pages available on the World Wide Web. The approval process configuration specifies the person or persons (at the company or otherwise) that have authority to approve transactions that the system generates.

In one embodiment of the invention, a Data Retrieval Application (23) is installed on the parent company and/or some or all of the subordinate entities' networks. The Data Retrieval Application (23) is initialized by the Connection Coordinator (22) which downloads (e.g., automatically downloads, or downloads upon command) the company structure information from the Company and Account Structure table (21A) and the monetary general ledger account information from a Monetary General Ledger table (21B) over, for example, the World Wide Web (e.g., the Internet). The monetary general ledger account information consists of specific data from those general ledger (GL) accounts within the ERP server or system where the currency of the account is different from the functional currency of the entity for which the account entry was made. These accounts are sometimes marked or flagged to be revalued at period closing to comply with general accounting standards. A revalued account is one in which the non-functional currency must be remeasured into the local or functional currency using the currency exchange rate on the date of period close. This revaluation process results in an unrealized gain or loss for the parent company which is reported on financial statements.

ERP systems can be configured to identify accounts that are to be remeasured during a system-run account revaluation process. If an ERP system does not support or is not configured for revaluation, the relevant accounts can be identified as those for which the account value is denominated in a currency other than the account's functional currency. Once the relevant accounts are identified, the query collects, for example, some or all of the following information for each account: entity number, entity name, account number, the account description, inter-company entity number, inter-company entity name, the non-functional currency, and the amount.

The Data Retrieval Application (23) then interfaces with the company's and/or each entity's accounting systems to obtain Company Data (24) using the monetary general ledger account information to select the non-functional currency transaction information. This information is then transferred back to the Monetary G/L table (21B). In one embodiment the non-functional currency transaction information is captured in a file or spreadsheet and uploaded via a web page accessible, for example, over the World Wide Web. In another embodiment, the non-functional currency transaction information is automatically transferred by the Data Retrieval Application as a block of XML over, for example, the World Wide Web.

If derivative products have been used, the client can enter information regarding the derivative products into the system by uploading a file or entering the data through a website. Information regarding the derivative products is stored in the Derivatives Table (21C).

The system (10) creates an Exchange Rate table (21D) based on, but not limited to, all of the currency exposures for all of the entities in the company. The table (21D) is populated using foreign exchange rate data obtained from an Exchange Rate Data Provider (28). The rate data includes, but is not limited to, prices from prior days' close, end of month close, end of week close, end of day close, or the current price. The system (10) uses this table (21D) to calculate the currency exposure for each individual entity. The currency exposure for an entity is its non-functional to functional currency exposure (e.g., GB Pounds to Euro exposure), where the entity has outstanding business transactions in the non-functional currency of a given type (accounts payable, accounts receivable, intercompany balances, cash, etc). After eliminating counter-balancing exposures within each netting group (if netting groups are used) and/or across the company and calculating the individual currency exposures for each non-functional currency of each entity, the system (10) sums all similar individual currency exposures. For example, if entities A, B and C each have a British Pound vs. Euro currency exposure, these three exposures would be summed to create a total British Pound vs. Euro currency exposure for the company. Similarly, companies A and C, might have a Yen vs. Euro exposure. These two Yen to Euro exposures would be summed to create a total Yen vs. Euro exposure for the company. Each total exposure for the company is converted to the company's reporting currency. Thus, following the previous example, and assuming that the reporting currency is US Dollars, the total British Pound vs. Euro exposure would be converted from British Pounds to dollars based on the current exchange rate (obtained from the Exchange Rate table (21D)). Similarly the total Yen vs. Euro exposure would be converted from Yen to US Dollars. In the next step, the system (10) calculates the overall exposure for the company. The overall currency exposure is the sum of all of the total currency exposures (i.e., the sum of all individual currency exposures), which were converted to the reporting currency in the previous step.

The system (10) then takes into account the derivatives owned by the company. The system (10) calculates the total derivative value for each currency exposure by summing all similar individual derivative values (e.g., all Canadian Dollar to US Dollar hedges are summed, all British Pound to US Dollar hedges are summed, etc.). For each currency exposure, the net currency exposure is calculated by subtracting the matching derivative position from each gross currency exposure. Each resulting net currency exposure is converted to the company's reporting currency and summed to obtain the overall net exposure for the company. The results are displayed to the client on a web page.

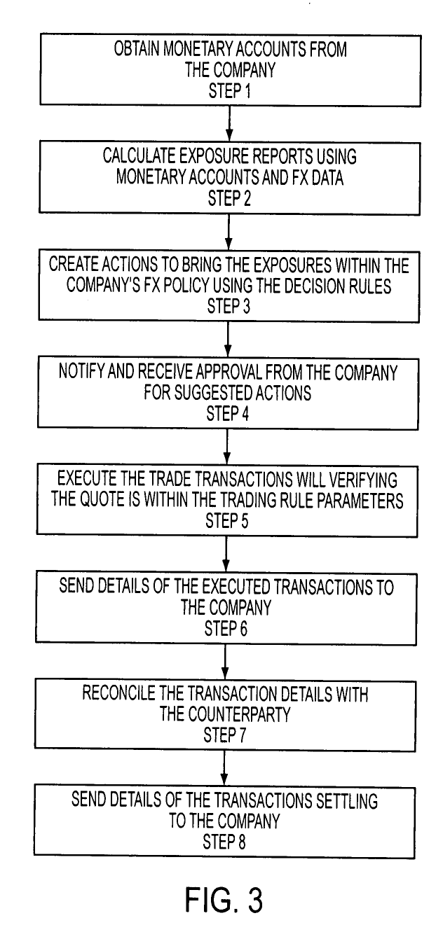

Referring to FIG. 3, a method for carrying out an embodiment of the invention will now be described. Each step in FIG. 3 is also referenced in FIG. 2 in order to show where the steps of the method would be carried out if performed on the system depicted in FIG. 2. As shown in Step 1, the system (10) queries the enterprise software of the company (58) to obtain the monetary accounts from the company's general ledger. After the enterprise software gathers the information, it is sent to the system (10). In addition, the client enters information regarding derivative positions by uploading a file or entering data through a website. When the monetary account and derivative data is received at the system (10), the process moves to Step 2, at which the system (10) obtains financial market data. Using the foreign exchange rates, queried data, and derivative data, the system (10) generates exposure reports that are displayed to the user on the website. The system (10) also calculates the overall gross currency exposure and overall net currency exposure of the company (58). At Step 3, the system (10) uses a set of rules to analyze the overall gross currency exposure and the overall net currency exposures to define the best possible actions for the company. The defined actions or “recommended actions,” are intended to bring the company's foreign currency exposures back in line with the company's currency risk policy parameters. The system (10) presents the recommended actions to the user along with other actions which, while not “recommended” since they do not comply with the company's preset parameters, are nevertheless possible. Any of these currency actions may be selected, deselected or edited. In Step 4, the system (10) seeks approval for whichever action is chosen by the user. In this Step, the appropriate person(s) of the company is notified of the chosen actions. If the actions are not approved then the user can edit the set of actions based upon the currently displayed net exposure and the available actions for that currency exposure. After the actions have been approved, currency transactions to carry out the chosen actions are initiated. At Step 5, the currency transactions are executed with a counterparty (12) (e.g., a financial institution, broker or other foreign exchange liquidity provider). In the case of a purchase or sale of a derivative, the currency transaction is executed when the counterparty quotation is within the trading rule parameters associated with the company (58).

In another embodiment of the invention, the system (10) (FIG. 1) manages the currency exposure of a parent company by converting one or more cash accounts for an entity of the company from the entity's non-functional currency to its functional currency. Cash conversions are done to reduce exposure from either excess cash accounts or accounts payable accounts. For example, assume that the parent company is a U.S. company, whose reporting currency is U.S. Dollars. Further assume that the parent company has a U.K. entity whose functional currency is Pounds, and which has one of its cash accounts denominated in U.S. Dollars. The Exposure Calculation engine (59) could identify this account, and the Decision Engine (62) could recommend that the Dollar cash account of the U.K. entity be converted into Pounds. This would reduce the foreign currency exposure of the U.K. entity (and thus reduce the parent company's exposure).

In still another embodiment, the system (10) manages the currency exposure of the parent company based on transactions that occur between two or more of the parent company's subordinate entities or between a subordinate entity and the parent company. In this embodiment, the Exposure Calculation engine (59) identifies transactions between two or more of the subordinate entities, or between the company and one of its subordinate entities (e.g., between the US Entity (54) and the German Entity (56)), which can be paid

In an additional embodiment, the system (10) manages the currency exposure of the parent company by suggesting a hedge position between two currencies that when executed as a derivative instrument would have the effect of reducing the exposure of the parent company.

Referring still to FIGS. 2 & 3, the details of the executed transactions are entered into the system (10) at Step 6. Those details are then sent to the company (58) for its records. At Step 7, the details of the currency transactions are reconciled with the counterparty. If the currency transactions do not match perfectly, then any discrepancies are resolved. When all currency transactions have been matched, Step 8 is performed. In Step 8, settlement information regarding the currency transactions are sent to the company (58) and to the counterparty (12) so that preparations can be made by the company (58) to send or receive funds.

Referring to FIG. 1, an example of how an embodiment of the invention operates will now be described. In this example, assume that the Company (58) has a US Entity (54), a French Entity (55), and a German Entity (56). The US Entity (54) has US Customers (14) and US Vendors (16). The French Entity (55) has a UK Customer (52), a UK Vendor (51), and a French Vendor (18). The German Entity (56) has a German Customer (20), Spanish Vendor (53), and German Vendor (22). The Functional Currency for the US Entity (54) is the US Dollar and the Functional Currency for the French (55) and German Entities (56) is the Euro. The Reporting Currency for the Company (58) is the US Dollar.

At the end of the reporting period, the French Entity (55) has an outstanding accounts receivable of 50,000 British Pounds (GBP) from its UK Customer (52) and an outstanding accounts payable of GBP 20,000 to its UK Vendor (51) (thus, a net receivable of GBP 30,000 (50,000−20,000) as of the end of the quarter. The French Entity's (55) monetary account data is stored in the Enterprise Software (24) of the Company (58). The German Entity (56) has an outstanding account receivable of GBP 25,000 from its UK Customer (52). The German Entity (56) also has an outstanding payable of 10,000 Euros (EUR) to its Spanish Vendor (53), but since that will be paid in Euros, which is the German Entity's functional currency, it has no impact on currency exposure. The German Entity's (56) monetary account data is stored in the Enterprise Software (24) of the Company (58).

The Enterprise Software (24) extracts the raw data (26) regarding the accounts payable and accounts receivable entered by the French Entity (55) and the German Entity (56) and transmits the raw data (26) to the system (10). The system (10), in this embodiment, operates in an Application Service Provider (ASP) hosted environment. The raw data (26) is received by an Exposure Calculation engine (59). The Exposure Calculation engine determines that the German entity (56) has an individual currency exposure of GBP 25,000 while the French entity (55) has an individual currency exposure of GBP 30,000. Therefore, the Exposure Calculation engine (59) determines that the total currency exposure for the Company (58) is GBP 55,000 (vs the Euro). The Exposure Calculation engine (59) also receives up-to-date exchange rate information from an FX Rate Source (64). Then, based on the reporting currency of the Company (58) being USD and assuming a GBPUSD exchange rate of 1.7450, the Exposure Calculation engine (59) determines that the Overall Currency Exposure for the Company (58) in terms of the reporting currency is USD 95,975 (1.7450×55,000). The Exposure Calculation engine (59) also receives information regarding derivatives either from the Settlement engine (60) or from the Company (58), which may upload a derivative data file or enter the derivatives data directly via the website. Based on the information from the Settlement engine (60), the Exposure Calculation engine (59) determines that the Company (58) has purchased a derivative instrument of (BUY GBP 45,000, SELL EUR) (e.g., to hedge the exchange rate risk of the GBP against the EUR). Given the same GBPUSD exchange rate, the value of the derivative is USD 78,525 (1.7450×45,000). Based on this information, the Exposure Calculation engine (59) determines that the overall net currency exposure for the Company (58) in its reporting currency is USD 17,450 (USD 95,975−USD 78,525). This amount will then be displayed on a web page (e.g., the web page 25 of FIG. 2) along with the overall gross currency exposure and the overall derivative value (which will also be displayed in USD).

In another embodiment of the invention, the system (10) analyzes the raw currency exposure data and the derivatives data (i.e., data used by the Exposure Calculation engine (59)), and makes decisions according to risk policies and decision preferences of the Company (58). Referring to FIG. 2, the risk tolerance parameters are entered into a Risk Tolerance table (21E). The preferences are entered into a Decision Rules table (21F), and then ranked in order. Risk tolerance parameters can very greatly from company to company. Some of the parameters entered into the Risk Tolerance table (21E) includes, but are not limited to, max/min dollar amount per non-functional currency, total dollar amount of currency exposure, percentage exposure per non-functional currency, total percentage of currency exposure, and target net currency exposure. Some of the decision preferences that the company can select include, but are not limited to, netting groups, timing of the settlement of inter-company transactions, minimum cash balances to be maintained, and types of derivative transactions. These preferences are converted into rules, which are stored in the Decision Rules table (21F). In addition, the Decision Rules table (21F) could include optimization factors such as interest rate differentials and volatility levels between functional and non-functional currencies. The system (10) will then compare the overall net currency exposure value as well as the total of each individual currency exposure (e.g., the total Yen-to-Euro exposure, the total GBP to USD exposure, etc.) to the values in the Risk Tolerance table (21E) to verify that the company's exposure in compliance with the company's foreign currency policy. If the overall net currency exposure and the individual currency pair exposures are within the parameters of the risk tolerances defined in the Risk Tolerance table (21E) then no further action is required. If the overall net currency exposure or the total exposure of any particular currency pair is outside of the risk tolerances, then the system (10) will suggest actions (via the website) to bring the company's exposure within the limits of its foreign currency policy. A Decision Process (31) uses the Risk Tolerance table (21E) to decide which total currency exposures need actions, and uses the Decision Rules table (21F) to determine which action is to be used next to bring the company within its risk tolerances. The suggested actions are stored in the Suggested Actions table (21G)

After the suggested currency action(s) have been created, the notification of the suggested action(s) is sent to the appropriated person(s) for approval (32). If the actions are not approved then the user can edit the set of actions based upon the currently displayed net exposure and the available actions for that currency exposure to bring the company (58) into compliance with its foreign exchange policy. The new suggested actions are sent to the appropriate authorized person(s) for approval. This process is repeated until the suggested action has been approved or the approver acknowledges and accepts that the company (58) is outside of its risk tolerance. After the suggested actions have been approved by the appropriate person(s), information regarding the currency transactions is then stored in the Currency Transactions table (21H).

Referring to FIG. 2, in another embodiment of the invention, the currency transaction(s) stored in the Currency Transactions table (21H) are executed (36) with a counterparty. The information in the Currency Transactions table (21H) is used to obtain relevant market information required to execute the transactions. This information includes, but is not limited to, price quote, interest rate for the country of the functional and non-functional currencies, and forward points from an Exchange Rate Data Provider (29). This information is stored (30) in a Rate Quote table (21I) to be used later by the Currency Transaction Execution process (36) to evaluate the quote received from the counterparty. A quote is then obtained from the trading desk or electronic trading platform of a counterparty for the currency transaction that was stored in the Currency Transactions table (21H) and that was also stored in the Rate Quote table (21I). The quote can be obtained via a website, File Transfer Protocol (FTP) site, phone call, email or any other form of communication with the counterparty. The information obtained from the Exchange Rate Data Provider (29) is used to evaluate the price quoted by the Trade Desk (37) of the counterparty. The system (10) then evaluates the price based on a set of trading rules, which include, but are not limited to, percentage difference between the quotes, difference between the quotes in units, and difference between the forward points of the quotes. If the counterparty quote (37) is within certain parameters that may change over time based on market conditions, then the currency transaction is executed. After the currency transaction is executed, data describing the transaction is imported into a Confirmations table (21J). Trade data may include, but is not limited to, counterparty bank, account number, transaction date, execution price, value date, buy currency, buy currency amount, sell currency, and sell currency amount. The currency transaction data may be entered into the Confirmation table (21J) by importing an electronic file or by entering the details through the website or by any other method.

Referring still to FIG. 2, another embodiment of the present invention takes the currency transactions data from the Confirmations table (21J) and reconciles trades and positions with the Back Office (38) of the counterparty. This aspect of the system (10) creates a currency transaction confirmation (35) that is sent to the Company (26), confirming the details of the transaction. A trade and/or position file from the counterparty Back Office (38) is then imported into the system (10). The file may be entered electronically or manually. This information is then reconciled (39) to the Confirmations table (21J), by comparing one or more of the following: account number, transaction date, execution price, value date, buy currency, buy currency amount, sell currency, and sell currency amount. The information from the Confirmations table (21J) should match the information imported from the counterparty. Any discrepancies are resolved with the counterparty Back Office (38). If the Confirmations table (21J) needs to be corrected then it is updated and a confirmation (25) is resent to the Company (26) with the details of the currency transaction, identifying the currency transaction as a correction. After all confirmations have been reconciled (39) and corrected, a settlement report (40) is generated and sent to the Company (26). This is done to insure the proper settlement of the currency transactions. All transactions are identified as such and are made available for use by the present system and method in future exposure calculations.

It can be seen from the foregoing that a new and useful method and system for identifying and managing currency exposure has been described. The use of the terms “a” and “an” and “the” and similar referents in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

We claim:

1. A method for determining the currency exposure for a company, the company comprising a plurality of entities, wherein the company reports financial data using a reporting currency, wherein each of the plurality of entities normally transacts business in a functional currency, and wherein at least one of the plurality of entities has one or more accounts denominated in one or more non-functional currencies, the method comprising:
(a) receiving, from an entity of the plurality, data representing the entity's accounts, wherein one or more of the accounts is denominated in a non-functional currency of the one or more non-functional currencies, thereby creating a currency exposure of the functional currency to the non-functional currency;
(b) obtaining the exchange rate between the functional currency and the non-functional currency;
(c) obtaining the exchange rate between the functional currency and the reporting currency;
(d) executing one or more computer programs that perform steps comprising
using the obtained exchange rates, calculating the amount of exposure to each of the one or more non-functional currencies;
converting each calculated amount into the reporting currency;
displaying each converted amount on a web interface;
calculating the company's overall gross currency exposure based on the one or more converted amounts; and
displaying the overall gross currency exposure on the web interface.

2. The method of claim 1, further comprising repeating step (a) for each of the plurality of entities.

3. The method of claim 2, wherein the functional currencies of at least two of the plurality of entities are different from one another.

4. The method of claim 2, wherein the plurality of entities comprises a first entity and a second entity, wherein the functional currency of first entity and the second entity is different, and wherein the functional currency of the first entity is the same as the non-functional currency of an account of the second entity, and wherein the functional currency of the second entity is the same as the non-functional currency of an account of the first entity, the method further comprising:
(e) offsetting accounts of the first and second entities against one another to eliminate at least a portion of the exposure between their respective functional and non-functional currencies.

5. The method of claim 2, wherein an account of at least one of the entities of the plurality is denominated in a currency that is different from the currency in which an account of at least one other of the entities is denominated.

6. The method of claim 5, wherein step (a) comprises establishing a network connection with the company, and receiving, via the network connection, a file containing the account data of the entity.

7. The method of claim 1, wherein step (a) comprises establishing a network connection with the company, and receiving, via the network connection, a file containing the account data of the entity.

8. The method of claim 1, further comprising:
(e) receiving, via a website, the data representing the entity's accounts; and
(f) providing the data to one or more computers that perform step (d).

9. The method of claim 1, further comprising:
(e) for each of the entity's exposures to a non-functional currency, determining whether there are one or more currency-based derivatives that hedge the exposure;
(f) if there are one or more currency-based derivatives that hedge the exposure, adjusting the amount of the exposure by the amount of the one or more currency-based derivatives;
(g) using the obtained exchange rates, converting each adjusted exposure amount into the reporting currency;
(h) after converting the adjusted exposure amounts into the reporting currency, summing the adjusted exposure amounts to obtain a net currency exposure; and
(i) displaying the net currency exposure on the web interface.

10. The method of claim 9, further comprising:
(j) based on the net currency exposure, identifying a currency-based derivative that the company should purchase in order to reduce its net currency exposure;
(k) requesting approval of the derivative purchase from the company; and
(l) upon approval of the company, purchasing the derivative.

11. The method of claim 1, further comprising:
prior to performing step (a), electronically collecting the data representing the entity's accounts.

12. The method of claim 11, wherein:
the electronically collecting comprises automatically collecting the data.

13. The method of claim 1 1, wherein:
the data includes at least one of the following: entity number, entity name, account number, the account description, inter-company entity number, inter-company entity name, the non-functional currency, and an amount of the non-functional currency.

14. A method for minimizing the currency exposure of a company, the company having a plurality of subordinate entities, each of the subordinate entities having a functional currency in which the subordinate entity normally transacts business, the method comprising executing one or more software modules that perform steps comprising:
(a) identifying an account of a first entity of the plurality in which a second entity of the plurality owes the first entity an amount of money denominated in a currency other than the second entity's functional currency;
(b) paying the account;
(c) identifying a cash account of the second entity that is denominated in a currency other than the second entity's functional currency;
(d) converting the cash account into the functional currency;
(e) identifying a derivative position that can be taken by the company to minimize the exposure of the company to a currency other than the second entity's functional currency; and
(f) executing a transaction to take the identified derivative position.

15. The method of claim 14, further comprising
(g) defining a table that contains the set of parameters, wherein the parameters define the company's foreign currency exchange risk tolerances;
(h) performing steps (a) through (f) in accordance with the set of parameters.

16. A system for minimizing a company's exposure to foreign currency risk, the company having a plurality of entities, each of the plurality of entities having a functional currency that the entity normally uses to transact businesses, the company having a reporting currency in which the company submits its financial reports, the system comprising:
a database;
one or more servers that perform steps comprising:
electronically receiving assets and liabilities data from the company over a public network;
retrieving, from the database, data regarding currency-based derivatives owned by the company;
for each of the plurality of entities, calculating the exposure that the entity has to a currency other than its functional currency;
displaying, on a web interface, each calculated exposure;
converting each calculated exposure into the reporting currency, resulting in a plurality of converted exposures;
summing the plurality of converted exposures to obtain an overall gross currency exposure for the company; and
displaying the overall gross currency exposure on a web interface.

17. The method of claim 16, further comprising:
for each exposure of each entity, determining whether there are one or more currency-based derivatives that hedge the exposure;
if there are one or more currency-based derivatives that hedge the exposure, adjusting the amount of the exposure by the amount of the one or more currency-based derivatives;
using the obtained exchange rates, converting each adjusted exposure amount into the reporting currency
after converting the adjusted exposure amounts into the reporting currency, summing the adjusted exposure amounts to obtain an overall net currency exposure;
displaying the net currency exposure on the web interface;
retrieving, from the database, foreign currency risk policy parameters for the company;
determining, using the overall net currency exposure and the foreign currency risk policy parameters, whether the company's exposure to foreign currency risk is at an acceptable level;
identifying, based on the determining step, one or more courses of action that can be taken to bring the company's exposure to foreign currency risk to an acceptable level; and
displaying, on the web interface, the identified courses of action.

18. The system of claim 17, wherein the one or more servers perform further steps comprising:
receiving, via the web interface, user approval of the one or more courses of action;
querying an individual at the company for approval of the approved courses of action; and
if the individual declines approval, identifying alternative courses of action.

19. The system of claim 17, wherein the one or more servers perform further steps comprising:
retrieving, from the database, data regarding decision parameters of the company; and
designating a subset of the identified courses of action as being recommended courses of action, the recommended courses of action falling within the decision parameters.

20. The system of claim 17, wherein the one or more servers performs further steps comprising:
receiving a user selection of one or more of the identified courses of action; and
displaying, on the web interface, the result of the selected courses of action.

21. The system of claim 17, wherein an identified action of the one or more identified actions is a derivative transaction, wherein the one or more servers performs further steps comprising:
receiving, from a user, a selection of the derivative transaction;
obtaining an electronic quote for the derivative transaction;
retrieving trading rule parameters from the database;
determining whether the electronic quote is within the trading rule parameters;
based on the determining step, executing the derivative transaction.

22. The system of claim 17, wherein an identified action of the one or more identified actions is a conversion of a cash account of an entity of the plurality of entities into the entity's functional currency from a currency other than the entity's functional currency, wherein the one or more servers performs further steps comprising:
receiving, from a user, a selection of the cash conversion;
obtaining an electronic quote for the cash conversion;
retrieving trading rule parameters from the database;
determining whether the electronic quote is within the trading rule parameters;
based on the determining step, executing the cash conversion.

23. The system of claim 17, wherein a first entity of the plurality of entities has an account payable to a second entity of the plurality of entities, the account payable being denominated in a currency other than the first entity's functional currency, and wherein an identified action of the one or more identified actions is the payment of the account payable.

24. A computer-readable medium of instructions for collecting data representing at least one account of an entity, the computer-readable medium of instructions comprising:
a first set of instructions for controlling a computer to query a ledger of the entity to locate information pertaining to the entity, the information including identification data pertaining to the entity and financial information pertaining to potential currency exposure of the entity; and
a second set of instructions for controlling a computer to collect the located information as collected entity information.

25. A computer-readable medium of instructions as claimed in claim 24, further comprising:
a third set of instructions for controlling a computer to provide the collected information over the Internet.
